(19) United States
(12) Patent Application Publication
(10) Pub. No.: US 2007/0210017 A1
(43) Pub. Date: Sep. 13, 2007

(54) Filter system for filtering water or wastewater and a method of operating the filter system

(76) Inventor: Donald John Mackay, Louisville, KY (US)

Correspondence Address: MEREK, BLACKMON & VOORHEES, LLC, 673 South Washington Street, Alexandria, VA, 22314, US

(21) Appl. No.: 11/370,147

(22) Filed: Mar. 8, 2006

(51) Int. Cl. B01D 29/46

(52) U.S. Cl. 210/792

(57) ABSTRACT

An active filter system having a filter bed formed from at least one layer of filter media and a method of operating the active filter system to filter water or wastewater. The filter media includes a plurality of plastic particles coated with an active material. Preferably, the active material is removed from the plastic particles by directing influent (i.e., untreated water) upwardly though the filter bed for a predetermined period of time. While the influent is directed upwardly through the filter bed, air is periodically directed upwardly through the filter bed so that the washing cycle includes a plurality of combined air and influent stages and a plurality of influent only stages. The coated plastic filter media particles have a specific gravity less than the specific gravity of the influent as well as the specific gravity of the combined air and influent washing fluid so that the coated plastic filter media remains buoyant during the washing cycle.

### FIELD OF THE INVENTION

The present invention is directed to water and/or wastewater filter systems for filtering impurities from a liquid. More particularly, the present invention is directed to a filter system having active filtering particles and a method of operating the filter system.

### BACKGROUND OF THE INVENTION

The Harberer process is a know method of producing and operating active filters to remove various organic and inorganic dissolved solids from water and wastewater. The Harberer process is disclosed in U.S. Pat. No. 4,208,281 the entire contents of which are hereby incorporated by reference. The filter bed includes buoyant plastic balls that are coated with an active material. Specifically, a liquid containing the active material is directed upwardly through the filter bed to cause the active material to be distributed on and adhere to the surfaces of the plastic balls at a predetermined flow rate. The active material is a carbon (sometimes referred to as powdered activated carbon or PAC) or other powdered material such as aluminum oxide that is maintained on the plastic balls through static electrical attraction. Subsequently, a liquid to be purified is directed upwardly through the active filter bed at a flow rate lower than the predetermined flow rate for the application of the active material to the plastic balls of the filter bed. Overtime, the performance capacity of the active material is degraded through a combination of adsorption of dissolved solids and blinding by accumulation of solid material at the surface. The spent or exhausted active material must be removed from the buoyant plastic balls and a new coating reapplied to the buoyant plastic balls. In prior applications, the removal of the active coating was accomplished by directing high volumes of treated or filtered water downwardly through the filter bed. The velocity of the filtered water is higher than the velocities of the liquid in the application step to expand the filter bed downward and flush out the spent carbon. This method is very inefficient as it uses high volumes of treated water that is directed to waste rather than provided for service.

### OBJECTS AND SUMMARY OF THE INVENTION

An object of the present invention is to provide a novel and unobvious active filter system and method of operating the active filter system to filter water or wastewater.

Another object of a preferred embodiment of the present invention is to provide a method of operating an active filter system that does not require a washing fluid to be directed in a direction opposite to the flow of influent during filtration thus considerably simplifying operation and structure of the filter system.

A further object of a preferred embodiment of the present invention is to obviate the need to use filtered water to remove the coating of active materials from the plastic media particles.

Yet another object of a preferred embodiment of the present invention is to provide a method of operating an active filter system that does not require high volumes of washing fluid to expand the filter bed downwardly to remove the coating of active material from the plastic media particles.

Still another object of a preferred embodiment of the present invention is to provide a method of operating an active filter system that effectively and efficiently removes spent coating of active material from the plastic media particles.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

In summary, one embodiment of the present invention is directed to a method of clarifying a liquid. The method comprises the steps of: (a) providing a filter having at least one layer of filter media for removing impurities from a liquid, the at least one layer of filter media being formed from particles having a specific gravity less than a specific gravity of the liquid being filtered such that the at least one layer of filter media remains buoyant during filtration; and, (b) during washing, passing a washing fluid upwardly through the at least one layer of filter media, the washing fluid having a specific gravity greater than the particles forming the at least one layer of filter media such that the at least one layer of filter media remains buoyant during washing.

Another embodiment of the present invention is directed to a method of washing a filter for filtering liquids. The method of washing comprises the steps of: (a) providing a filter having at least one layer of filter media; and, (b) during a stage of a washing cycle, directing a combination of air and a washing liquid through the at least one layer of filter media, the combination of air and washing liquid having a specific gravity greater than the particles forming the at least one layer of filter media such that the at least one layer of filter media remains buoyant as the combination of air and washing liquid passes through the at least one layer of filter media.

A further embodiment of the present invention is directed to a method of washing a filter having at least one layer of filter media formed from a plurality of buoyant particles coated with an active material. The method comprises the step of: (a) directing a washing fluid upwardly through the at least one layer of filter media to remove at least some of the active carbon from the buoyant particles. The washing fluid has a specific gravity greater than the buoyant particles coated with the active material so that the at least one layer of filter media remains buoyant during washing of the filter.

### BRIEF DESCRIPTION OF THE DRAWINGS

FIG. 1 is a fragmentary elevation view of a preferred active filter system operating in a preferred filtration cycle.

FIG. 2 is a fragmentary elevation view of a preferred active filter system operating in a stage of a preferred flush cycle.

FIG. 3 is a fragmentary elevation view of a preferred active filter system operating in a preferred coating stage.

FIG. 4 is a fragmentary elevation view of an alternative active filter system operating in a flush cycle.

### DETAILED DESCRIPTION OF THE PREFERRED EMBODIMENTS OF THE INVENTION

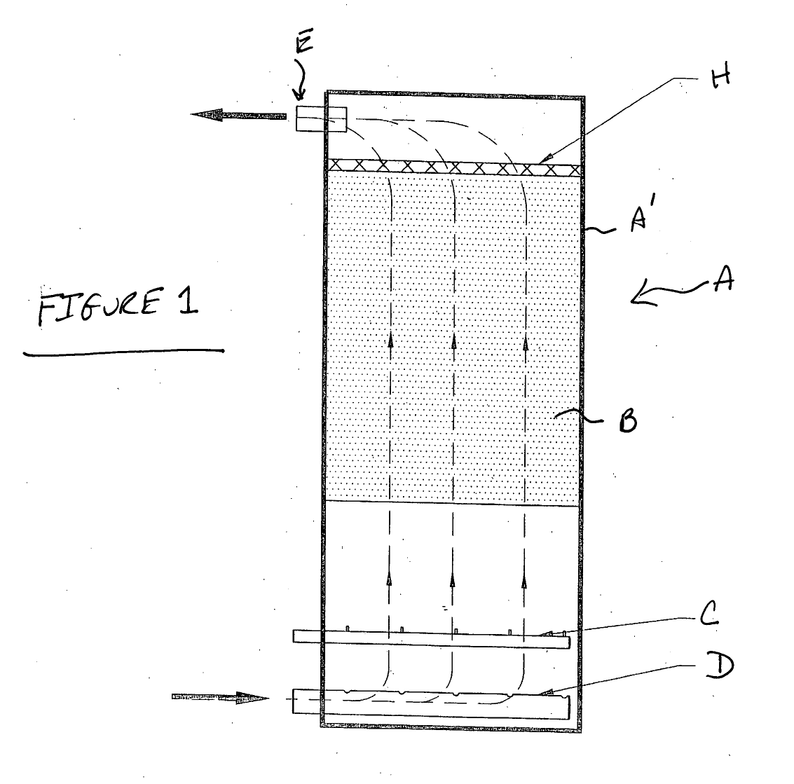

The preferred forms of the invention will now be described with reference to FIGS. 1-4. The appended claims are not limited to the preferred forms and no term and/or phrase used herein is to be given a meaning other than its ordinary meaning unless it is expressly stated that the term and/or phrase shall have a special meaning. The term filter as used herein is to broadly interpreted to include a device in which at least a portion of the impurities in a liquid are removed including but not limited to a clarifier, a polishing filter and/or a contactor.

### FIGS. 1-3

Referring to FIGS. 1 to 3, a portion of a filter system A is illustrated in one of many possible configurations. The filter system A includes a filter housing A′, a filter bed B, an air conduit C, an influent distribution manifold D, an effluent discharge port E, a waste discharge port F, a carbon slurry container G and a media retaining screen H.

The effluent discharge port E and waste discharge port F are typically opposing ports on a T (not shown) that extends outwardly from the filter housing A′. When liquid is to flow to waste the T is adjusted so that flow is only through the waste discharge port F. When liquid is to be used in service, the T is adjusted so that flow is only through the effluent discharge port E. However, it will be readily appreciated that numerous other configurations could be used.

The filter bed B includes at least one layer of filter media formed from buoyant plastic particles that are coated with an active material. Preferably, the filter media is formed from polystyrene. The active material is preferably a powdered adsorbent held on to the plastic material by static electrical attraction. It should be noted that powdered carbon (sometimes referred to as powered activated carbon or PAC) can be used as the active material. However, it will be readily appreciated that any suitable coating can be used including but not limited to aluminum oxide. Preferably, the coated buoyant plastic particles have a specific gravity less than the specific gravity of the washing fluid combination of air and liquid. Most preferably, the specific gravity of the coated buoyant particles is in the range of approximately 0.5 to approximately 0.8. The low specific gravity of the coated buoyant particles allow the filter bed to remain buoyant in the filtration cycle and washing cycle.

During a filtration cycle, as seen in FIG. 1, influent (i.e., untreated liquid) is directed upwardly through the filter housing A′ by the influent distribution manifold D. The flow rate of the influent is preferably in the range of 4 to 10 gpm/sq.ft. However, it will be readily appreciated that the influent flow rate during the filtration cycle maybe varied as desired. The influent maybe either wastewater or water. At least a portion of the impurities of the liquid are retained in the filter bed B. The specific gravity of the particles forming the filter bed is less than the influent such that the filter bed B remains buoyant and does not descend downwardly during the filtration cycle. The media retaining screen H acts as a stop and prevents the escape of media from the housing A′.

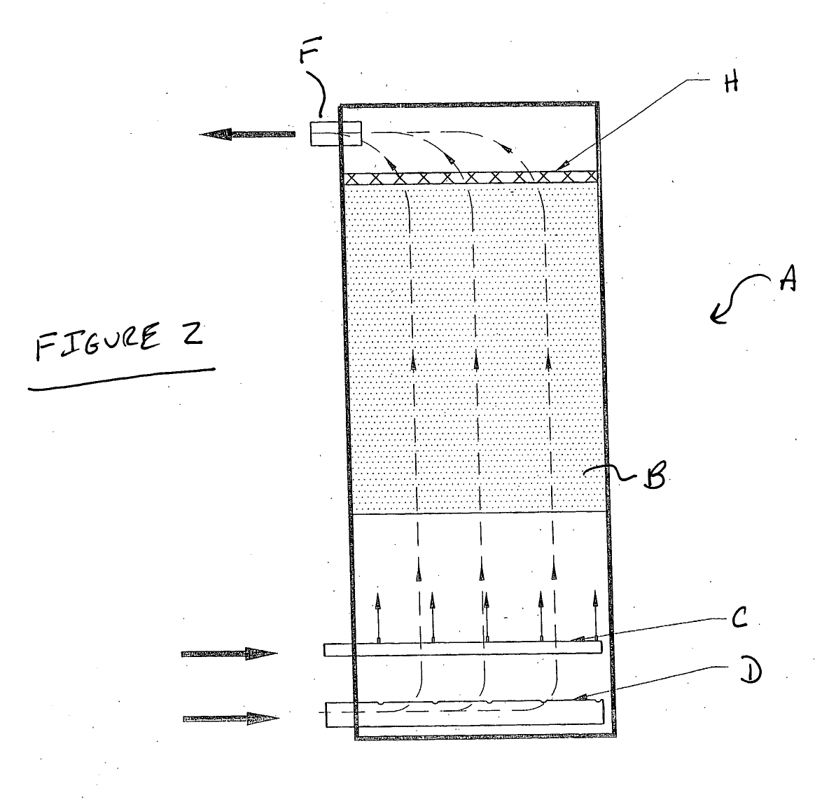

Overtime, the performance of the filter bed B becomes degraded through a combination of adsorption of dissolved solids and blinding by the accumulation of solid material at the surface. The spent coating must be removed. To accomplish the removal of the spent coating, influent is directed upwardly by the influent manifold D through the filter bed B to waste through waste discharge conduit F for a predetermined period of time as seen in FIG. 2. Preferably, the influent flow remains on throughout the entire washing cycle. The velocity of the influent is preferably in the range of 4 to 10 gpm/sq.ft. and most preferably approximately 10 gpm/sq.ft. During the washing cycle, air is periodically directed upwardly by the air conduit C while the influent is being directed through the filter bed B such that the washing cycle includes one or more combined air and influent washing fluid stages. The air scour rate, i.e., the rate that air is directed into the air conduit C, is preferably in the range of approximately 6 to approximately 8 scfm/sq.ft. Preferably, the air flow is discontinued during the washing cycle such that the washing cycle includes one or more influent only washing stages following one or more combined influent and air stages. The specific gravity of the combined influent and air washing fluid is less than the specific gravity of the coated filter media particles so that the filter media particles remain buoyant during both the combined air and influent stage and influent only stage of the washing cycle. It may be necessary that a given washing cycle include five or more combined air and influent stages each directly followed by an influent only stage to remove all of the carbon from the buoyant particles. The combined influent and air can be run for approximately a half a minute to approximately a minute while the influent only stage can be run for approximately a minute to approximately a minute and a half. The final influent only stage, preferably the final stage in the washing cycle, may be run for three to five minutes to properly rinse the remaining carbon. However, it will be readily appreciated that the duration of the washing stages, the order of the washing stages and the velocity of the washing fluids of the washing cycle may be varied as desired.

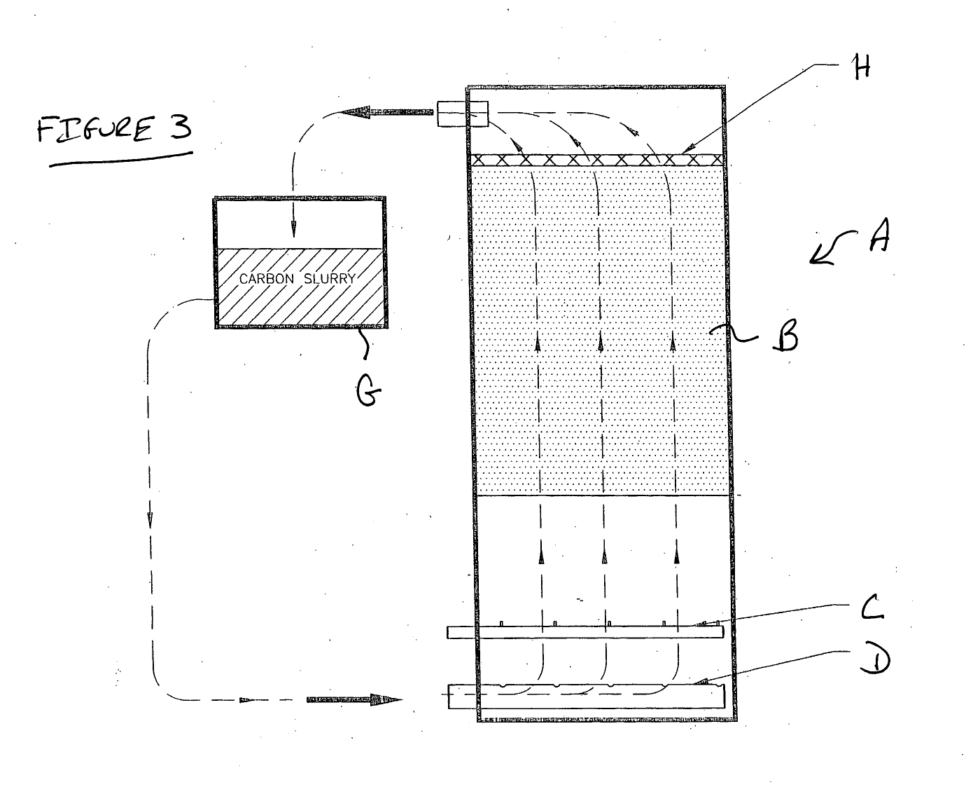

As seen in FIG. 3, the carbon is reapplied by directing a liquid through container G housing a carbon slurry and subsequently directing the carbon slurry upwardly through the filter bed B. Once the media particles have been properly coated, the filter system is readily to be returned to service.

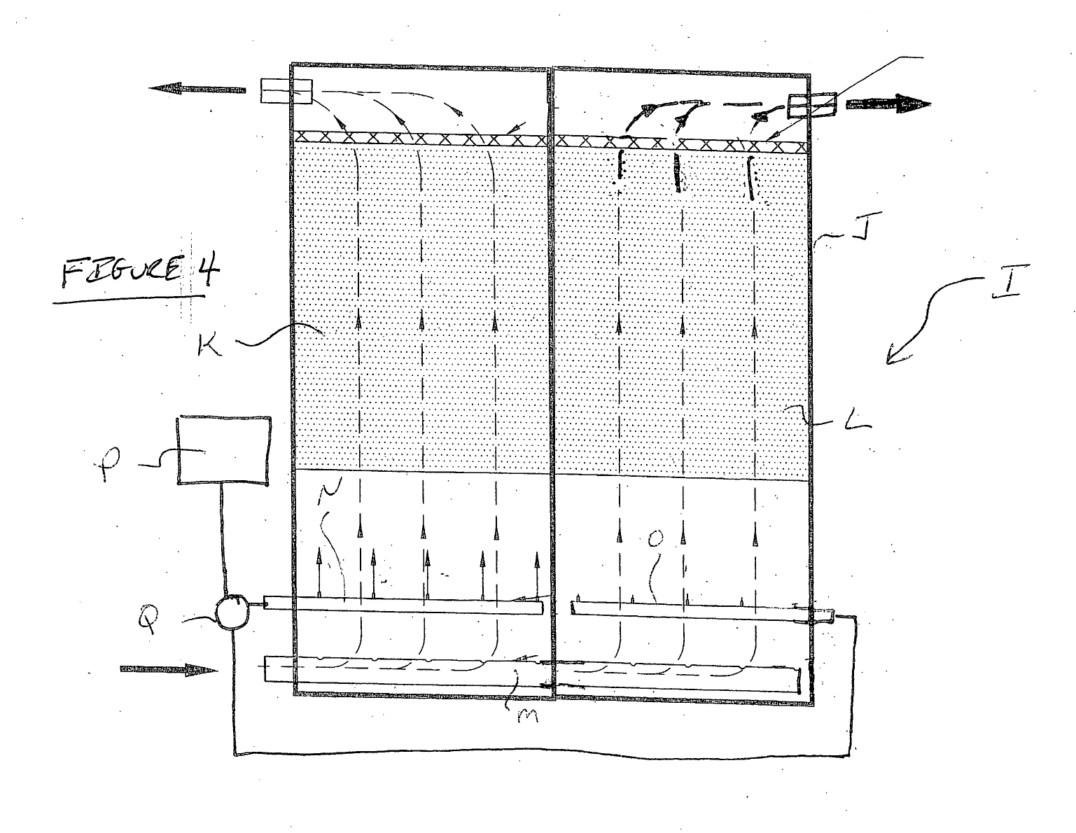

### FIG.4

Referring to FIG. 4, an alternative filter system I will now be described. Because filter I is similar to filter system A depicted in FIGS. 1 to 3 only the differences will be described in detail. The filter system I includes a filter housing J that has two filter cells K and L. While only two filter cells are shown, it will be readily appreciated that the filter housing J may include three or more cells. Preferably the filter cells K and L share a common influent manifold conduit M. Filter cells K and L include air distribution conduits N and O, respectively. The air distribution conduits N and O are connected to an air source P via valve Q. Valve Q selectively directs air to the air distribution conduits N and O. Therefore, when cell K is in a liquid only stage of the wash cycle, air can be directed to cell L. Similarly, when cell L is in a liquid only stage air can be directed to cell K. In this manner, the filter system I eliminates the need to start and stop the air source P.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

I claim:

1. A method of clarifying a liquid, said method comprising the steps of:
(a) providing a filter having at least one layer of filter media for removing impurities from a liquid, said at least one layer of filter media being formed from particles having a specific gravity less than a specific gravity of the liquid being filtered such that said at least one layer of filter media remains buoyant during filtration; and,
(b) during washing, passing a washing fluid upwardly through said at least one layer of filter media, said washing fluid having a specific gravity greater than said particles forming said at least one layer of filter media such that said at least one layer of filter media remains buoyant during washing.

2. A method as recited in claim 1, wherein:
(a) said washing fluid includes air.

3. A method as set forth in claim 1, wherein:
(a) said washing fluid includes a combination of air and liquid.

4. A method as set forth in claim 1, wherein:
(a) said washing fluid includes a combination of air and influent.

5. A method as set forth in claim 1, wherein:
(a) said at least one layer of filter media is formed from plastic particles, said plastic particles are at least partially coated with an active material.

6. A method as set forth in claim 5, wherein:
(a) said active material is an adsorbent material.

7. A method as set forth in claim 6, wherein:
(a) said adsorbent material is active carbon.

8. A method as recited in claim 7, including the further step of:
(a) during filtration, directing influent upwardly through said at least one layer of filter media to remove impurities from the influent.

9. A method as recited in claim 8, wherein:
(a) the velocity of the influent during filtration ranges from 4 to 10 gpm/sq.ft.

10. A method as recited in claim 4, wherein:
(a) the velocity of the air during backwashing ranges from 6 to 8 scfm/sq.ft.; and,
(b) the velocity of influent during backwashing ranges from 4 to 10 gpm/sq.ft.

11. A method of washing a filter for filtering liquids, said method of washing comprising the steps of:
(a) providing a filter having at least one layer of filter media; and,
(b) during a stage of a washing cycle, directing a combination of air and a washing liquid through said at least one layer of filter media, said combination of air and washing liquid having a specific gravity greater than said filter media forming said at least one layer of filter media such that said at least one layer of filter media remains buoyant as said combination of air and washing liquid passes through said at least one layer of filter media.

12. A method as recited in claim 11, further including the step of:
(a) during a stage of a washing cycle, directing only a washing liquid though said at least one layer of filter media, said washing liquid having a specific gravity greater than said filter media forming said at least one layer of filter media such that said at least one layer of filter media remains buoyant as said washing liquid passes through said at least one layer of filter media.

13. A method as recited in claim 11, wherein:
(a) said at least one layer of filter media is formed from a plastic material at least partially coated with active carbon.

14. A method as recited in claim 13, wherein:
(a) said combination of air and washing liquid is directed upwardly through said at least one layer of filter media at a sufficient velocity to remove at least some of the active carbon from the plastic material.

15. A method as set forth in claim 12, wherein:
(a) said stage of a washing cycle in which only a washing liquid is directed upwardly though said at least one layer of filter media is performed at an end of a washing cycle.

16. A method as recited in claim 11, wherein:
(a) said stage of the washing cycle in which a combination of air and a washing liquid is used is performed for a shorter period of time than said stage of the washing cycle in which liquid only is used.

17. A method of washing a filter having at least one layer of filter media formed from a plurality of buoyant particles coated with an active material, said method comprising the step of:
(a) directing a washing fluid upwardly through said at least one layer of filter media to remove at least some of the active carbon from said buoyant particles, said washing fluid having a specific gravity greater than said buoyant particles coated with the active material so that said at least one layer of filter media remains buoyant during washing of said filter.

18. A method as recited in claim 17, further including the steps of:
(a) directing influent upwardly through said at least one layer of filter media for a predetermined period; and,
(b) directing air upwardly through said at least one layer of filter media for only a portion of said predetermined period such that said washing cycle includes at least one combined air and liquid washing stage and at least one liquid only washing stage.

19. A method as recited in claim 18, further including the step of:
(a) periodically directing air upwardly through said at least one layer of filter media during said predetermined period such that said washing cycle includes a plurality of combined air and liquid washing stages and a plurality of liquid only washing stages.

20. A method as recited in claim 17, wherein:
(a) said filter includes a plurality of filter cells each having at least one layer of filter media formed from a plurality of buoyant particles coated with an active material;
(b) directing influent upwardly through said at least one layer of filter media for a predetermined period; and,
(c) directing air upwardly through each of said plurality of filter cells one at a time during said predetermined period such that the combination of air and washing liquid only passes through one of said plurality of filter cells at any given time during said predetermined period.
